(19) United States
(12) Patent Application Publication
(10) Pub. No.: US 2013/0290409 A1
(43) Pub. Date: Oct. 31, 2013

(54) DEVICE AND METHOD FOR TRANSPORTATION DATA COLLECTION

(71) Applicant: James Harmen Beeksma, North York (CA)

(72) Inventor: James Harmen Beeksma, North York (CA)

(21) Appl. No.: 13/861,450

(22) Filed: Apr. 12, 2013

Related U.S. Application Data
(60) Provisional application No. 61/624,274, filed on Apr. 14, 2012.

(51) Int. Cl. H04L 29/08; G06Q 50/30; G06F 3/0481

(52) U.S. Cl. CPC H04L 67/10; G06Q 50/30; G06F 3/0481
USPC 709/203; 715/765

(57) ABSTRACT

A device and method for transportation data collection are provided. Data collection setup information is received on the device from a server. A data collection application for inputting data is displayed on a screen of the device and the application is configured with the data collection setup information. A user may input data, such as transportation data, using the data collection application. The collected data is stored on the device and is later transmitted to the server. Positioning and time information may collected by the device and stored with the collected data. The stored data is automatically deleted from the device after the data has been transmitted to the server.

### CROSS-REFERENCE TO RELATED APPLICATIONS

The instant application claims priority from U.S. Provisional Patent Application Ser. No. 61/624,274 filed on Apr. 14, 2012, the disclosure of which is incorporated herein by reference.

### TECHNICAL FIELD

The present invention relates to transportation data collection. More particularly, the invention relates to a device and method of collecting and transmitting transportation data.

### BACKGROUND OF THE INVENTION

Every year millions of surveys recording the movement of vehicles and pedestrians are performed worldwide as a necessity for the operations, design and planning of public transportation infrastructure and private business intelligence.

In conventional solutions, the traffic and/or transportation industry is using outdated survey equipment that leads to inaccurate survey setup and input recordings. Particularly, conventional equipment used for collecting traffic survey data is not readily available (i.e., not mass consumer produced) and requires long processing times to summarize the data into a useful end user format. For example, conventional equipment is specifically used in collecting traffic volumes with limited function expansion capabilities.

Another drawback of conventional solutions is that the collected traffic data is not auditable or easily manipulated. For example, conventional solutions do not provide GPS or universal time stamping audit recordings that confirm the universal time and location of recordings.

As well, in conventional solutions, equipment setup is done manually by the surveyor. As the initial setup is initially difficult, it frequently leads to inaccurate recording or it requires editing the data afterward.

Also, existing equipment generally does not have compass orientation technology that prevents surveyors from setting up the direction (i.e., facing north or south) of inputs incorrectly. If this occurs and is caught by the end user, it increases processing time or if not caught by the end users, it leads to inaccurate information to engineering professionals making decisions based on this information.

Additionally, conventional industry equipment requires a wired connection to a computer to retrieve the raw data which results in increased processing times.

### SUMMARY OF THE INVENTION

The present application provides a device and method for transportation data collection. Data collection setup information is received on the device from a server. A data collection application for inputting data is displayed on a screen of the device and the application is configured with the data collection setup information. A user may input data, such as transportation data, using the data collection application. The collected data is stored on the device and is later transmitted to the server. Positioning and time information may collected by the device and stored with the collected data. The stored data is automatically deleted from the device after the data has been transmitted to the server.

According to the present application, there is provided a method of data collection, the method comprising receiving, on an electronic device, data collection setup information from a server; generating, for display on a graphical interface screen of the electronic device a data collection application configured with the data collection setup information; receiving, through the data collection application, user inputted transportation data; storing, on the electronic device, the collected transportation data; and transmitting, to the server, the collected transportation data. The method may further comprise automatically deleting, from the electronic device, the stored collected transportation data immediately after the collected transportation data is transmitted to the server. As well, the electronic device may be configured to automatically receive the data collection setup information prior to a scheduled data collection project.

According to the present application, there is also provided an electronic device, comprising: a processor; a memory for storing transportation data; and a communications subsystem; the processor being configured to: receive data collection setup information from a server; generate, for display on a graphical interface screen a data collection application configured with the data collection setup information; receive, through the data collection application, user inputted transportation data; store, in the memory, the collected transportation data; and transmit, to the server, the collected transportation data. The processor of the device may be further configured to automatically delete the stored collected transportation data immediately after the collected transportation data is transmitted to the server.

According to the present application, there is provided a non-transitory computer readable storage medium having instructions stored thereon, which when executed by a processor for facilitating data collection, the processor performs the method of receiving data collection setup information from a server; generating, for display on a graphical interface screen of the electronic device a data collection application configured with the data collection setup information; receiving, through the data collection application, user inputted transportation data; storing, on the electronic device, the collected transportation data; and transmitting, to the server, the collected transportation data. The instructions may further comprise automatically deleting, from the electronic device, the stored collected transportation data immediately after the collected transportation data is transmitted to the server.

### BRIEF DESCRIPTION OF THE DRAWINGS

Reference is now made to the following drawings:

FIG. 1 illustrates communication between a server system and a surveyor device, according to an embodiment of the present application;

FIG. 1A illustrates a cloud-based data management system, according to an embodiment of the present application.

FIG. 2 illustrates a home screen site map for accessing the traffic data collection application, according to an embodiment of the present application;

FIG. 3 illustrates a project job data collection process, according to an embodiment of the present application;

FIG. 4 illustrates a home GUI screen, according to one embodiment of the present application;

FIG. 5 illustrates a open project jobs GUI screen, according to one embodiment of the present application;

FIG. 6 illustrates a project details GUI screen, according to one embodiment of the present application;

FIG. 7 illustrates a location confirmation GUI screen, according to one embodiment of the present application;

FIG. 8 illustrates a survey setup GUI screen, according to one embodiment of the present application;

FIG. 9 illustrates a survey recording GUI screen, according to one embodiment of the present application;

FIG. 10 illustrates a road conditions GUI screen, according to one embodiment of the present application;

FIG. 11 illustrates an incident reporting GUI screen, according to one embodiment of the present application;

FIG. 12A illustrates a project detail confirmation GUI screen, according to one embodiment of the present application;

FIG. 12B illustrates a lane configuration GUI screen, according to one embodiment of the present application;

FIG. 13 illustrates an additional information GUI screen, according to one embodiment of the present application; and

FIG. 14 illustrates a confirmation and upload GUI screen, according to one embodiment of the present application.

### DETAILED DESCRIPTION OF EXAMPLE EMBODIMENTS

Example embodiments of the present application provide a device and method for collecting and transmitting traffic data. The present application provides a software application that aims to utilize existing advanced touch screen mobile device technology and provide features that overcome data quality problems and processes that exist with using existing manual data collection technologies. Particularly, the software application of the present application may be used on smartphone or tablet devices, for example iPhone™ and iPad™ and the software application integrates with a cloud based data management system to minimize setup and data collection errors by the surveyors.

A client or end user may be a public or private agency or an individual willing to pay for traffic survey data. A survey contractor (also may be referred to as a “surveyor”) may be an independent individual user who will collect traffic survey data for a fee. A project may be a data collection survey that has a specific location, time collection periods and traffic data survey type. The project may require multiple survey contractors and/or multiple survey periods, and therefore may be separated as project jobs within the same project. Project jobs may be a data collection job that is assigned to one survey contractor to perform a specific data collection job within a project.

The surveys may be related to traffic, transportation and transit operations. The results of the surveys may be used in the planning, design and operations of transportation and transit systems. Traffic data, which may also be referred to as transportation data, includes statistics on vehicle and pedestrian movements. The vehicular traffic may include motorized vehicles (e.g., cars, buses, trains) and may include non-motorized vehicles (e.g., bicycles). As well, the traffic data may include pedestrian traffic movements, such as individuals walking through an intersection. The traffic survey recordings may include metrics such as volume of traffic, speed, type of traffic, vehicle spacing, vehicle queuing, acceleration, travel delay, travel time, saturation to measure capacity, origin-destination, roadside surveys, collision report, transit frequency, occupancy, etc. Also, traffic data may be documented in the form of a video recording, audio recording, photograph, word processing document, spreadsheet document (for example a comma-separated values (csv) file), etc.

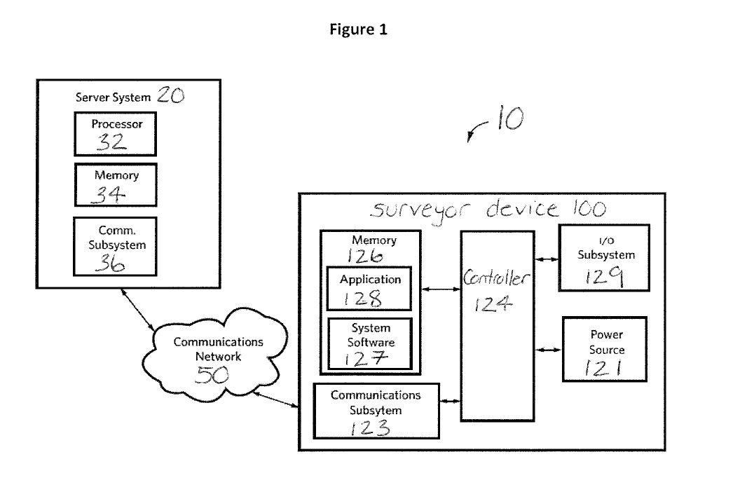

FIG. 1 illustrates an example diagram of system 10 for communication between a server system 20 and a surveyor device 100. As shown, the server system 20 may communicate with the employer device 100 over a communication network 50, such as a wireless network or the Internet. As well, the communication network 50 may be a cellular network.

The server system 20 may be configured as a web server which provides a cloud-based data management system. As shown in FIG. 1, in some example embodiments, the server system 20 may include one or more processors 32, at least a memory 34 for storing system software and databases for traffic data, and at least a communications subsystem 36. The memory 34 of the server system 20 may include a database of projects, the projects containing associated information such as traffic data, location information, time information, and survey contractor identification.

As shown in FIG. 1A, the cloud-based data management system 55 may include a data module 60 that provides a repository where all traffic data collected is stored for future use by either all clients wishing to purchase the data or held privately by a client owner of the data. The data module 60 facilitates the storage of open and completed project jobs. Data collected by the surveyor's device 100 may be transmitted to the data module 60 via the communications network 50.

In one embodiment, the data module 60 automatically merges the received traffic data from multiple surveyor devices 100 and/or multiple survey periods into a single report file, when multiple surveyors are required for a busy intersection traffic survey or multiple survey time periods are required. For example, some traffic surveys require multiple surveyors (devices) and the data module 60 may merge the received traffic data from multiple surveyor devices to produce a single data collection project. As the data on each surveyor device 100 is dependent on one another, missing traffic information on one leg of an intersection makes the entire survey useless.

As shown in FIG. 1A, the cloud-based data management system 55 may include a software module 70 that provides the software and setup information to provide the surveyor device 100 with applications to collect and transmit traffic data. For example, once a surveyor is awarded a project job, the software module 70 may transmit project setup data to the surveyor device 100 prior to the survey date, which eliminates existing surveyor device setup errors. As well, the software module 70 may provide the surveyor device 100 software applications to be installed prior to the survey date to facilitate the recording of manual observation events of the specific survey. Alternatively, the surveyor may download to their device the data collection software application from various application stores.

The surveyor device 100 may include one or more client applications 128. In some example embodiments, the surveyor device may include a controller 124 such as a microprocessor, which controls the overall operation of the surveyor device 100. The controller 124 interacts with other device components such as memory 126, and system software 127 stored in the memory 126 for executing the applications 128, input/output subsystems 129 (e.g., a keyboard, touchpad, scrollwheel, and/or a display) and a communications subsystem 123. A power source 121 powers the surveyor device 100. As well, the surveyor device 100 may include a global positioning system (GPS) or local positioning system (LPS), as understood in the art, for identifying the location of the surveyor device 100.

Referring to FIG. 1, the surveyor device 100 may be, for example, a computer, a tablet computer, mobile phone, or other portable electronic device. Some example embodiments may include the use of a dedicated installed mobile device software application (the “application”) on the surveyor device 100. The surveyor device 100 functions as a manual traffic data collection device and is used to record and collect traffic data. The application may facilitate traffic data collection and completion of traffic data surveys. Accordingly, specialized equipment that only functions for the purpose of data collection is not required in the present system. As shown in FIG. 1, a surveyor device 100 may be a mobile electronic device (for example, an Apple™ iPhone™ or iPad™, an Android™ device, a Windows™ device, a Blackberry™ device etc.) that has a touch screen, wireless data transfer capabilities (for example, Wi-Fi, 3G, 4G etc.) and GPS/LPS capabilities.

In one embodiment, the application will communicate with the software-as-a-service (SaaS) cloud-based data management system 55 via a specially designed JavaScript Object Notation application programming interface (JSON API). Upon authentication/verification, the application will be free to read data from relevant project posts and submit completed job surveys. All communication may be performed via a GET/JSON specification, with the exception of photo uploading, which may be completed via POST/JSON. In other embodiments, the communication is facilitated with a non-JSON format API.

The application for the surveyor's device 100 integrates with the cloud based data management system 55 and minimizes setup and data collection errors by the survey users. The application provides the surveyor the ability to accurately record multiple classes of data. As well, survey flexibility is improved by providing software architecture to accommodate receiving setup information and sending recordings between the cloud-based data management system 55 for multiple types of surveys on one surveyor device software application.

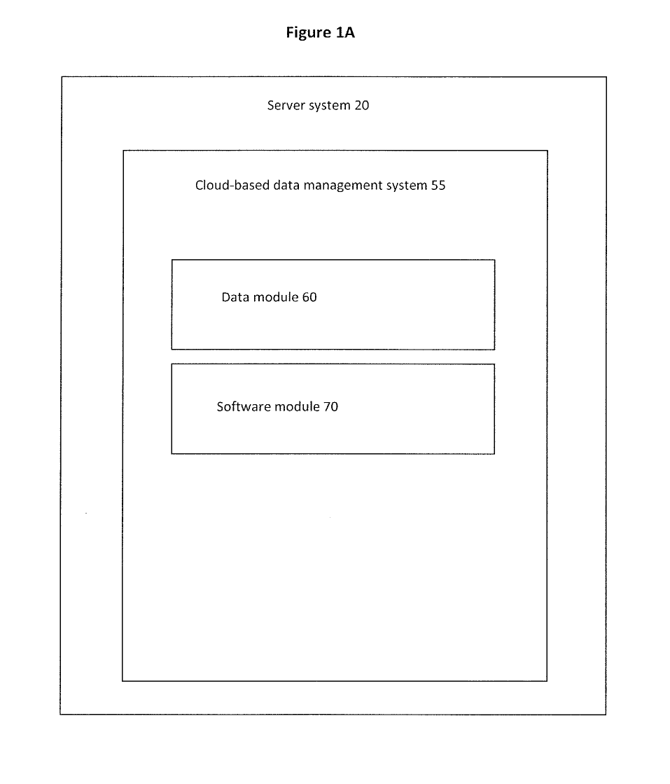

Reference is made to FIG. 2, which shows a home screen sitemap 200 for the software application in accordance with an example embodiment. The home screen 202 of the software application provides access to four static screen pages that are accessible to everyone who has installed the software application: tutorial 204, open project jobs 206, contact us 208, and logout 210. In order to access the screen pages, a user may login on an initial login page.

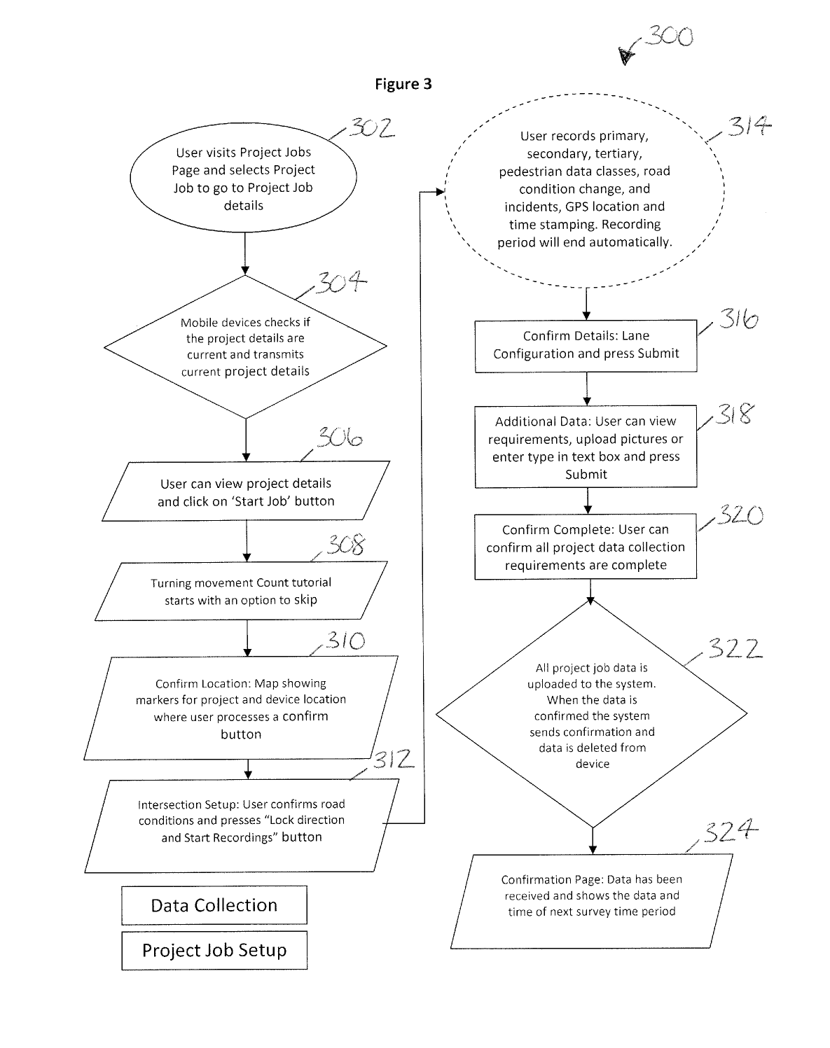

The tutorial 204 screen page provides information to a user (i.e., surveyor) on how to conduct surveys and how to use the software application in conducting surveys. From the open project jobs 206 screen page, there is provided a list of all active survey project jobs for that user. The contact us 208 screen page generates a new email message to the cloud-based data management system 55 service provider that the user may further compose. Finally, the logout 210 screen page logs the user out of the software application. FIG. 4 illustrates an example graphical user interface (GUI) home screen 400 for an IPhone™ device. The home screen 400 has user-selectable buttons tutorial 402, open project jobs 404, contact us 406 and logout 408 to access these screens of the software application.

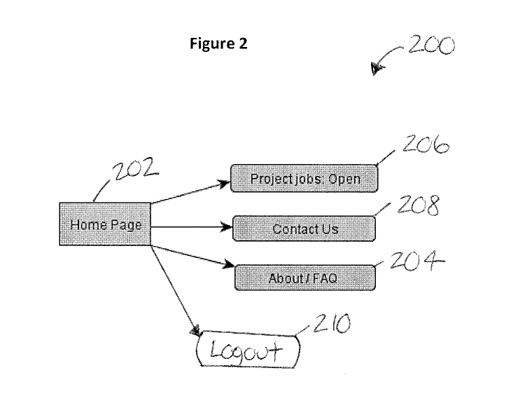

As shown in FIG. 3, there is provided a project job data collection process 300, according to one embodiment of the present application. The process ensures that all data is collected prior, during and after each individual survey time period. The process 300 may be applied to different types of transportation data collection surveys. As well, a surveyor may also be referred to as a user in the project job data collection process described below.

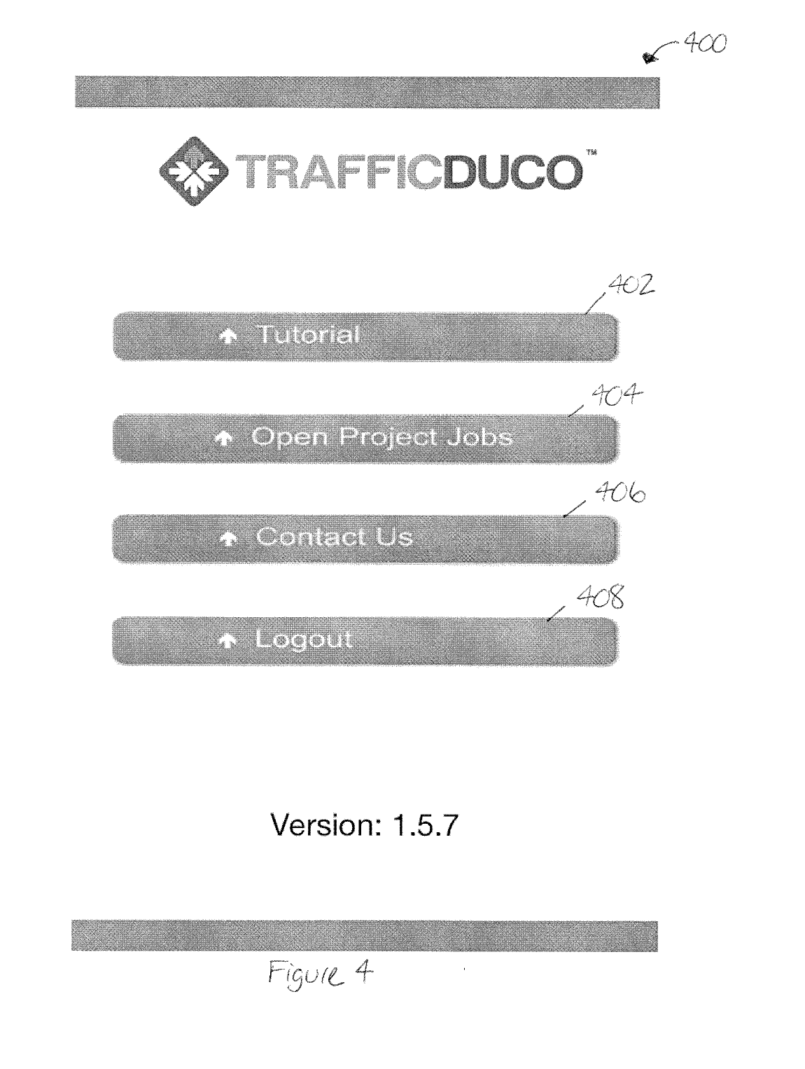

A user first visits the open project jobs 206 page and selects a project job in order to view the project job details (block 302). FIG. 5 illustrates an example GUI open project jobs screen 500 for an IPhone™ device. As shown, the open project jobs 500 screen lists the project jobs open and assigned to the user. The listed project job 502 identifies the date and time the survey is to begin and identifies the location for the survey.

The surveyor's device 100 determines if the project details are current (block 304). Data collection project setup data prepared by the cloud-based data management system 55 is wirelessly transmitted and pushed to the surveyor's device 100 prior to the survey date and prior to the user proceeding with any data collection project job. As well, the current version of the application software and/or any software updates, are automatically uploaded to the surveyor's device 100 prior to proceeding with any data collection project job. Accordingly, survey site information setup errors are eliminated by surveyors as all the project setup information is inputted by industry professionals on the cloud-based data management system 55 and transmitted to the software application on the surveyor's device 100 prior to the survey date. As shown in FIG. 5, the user may select a refresh icon 506 to determine if the information listed on the open project jobs screen 500 is accurate and complete. As well, the user may select to return to the home screen 400 by selecting the home 504 icon. Data collection project setup data may include information relating to survey location, survey date and time period, and type of data classes to be recorded.

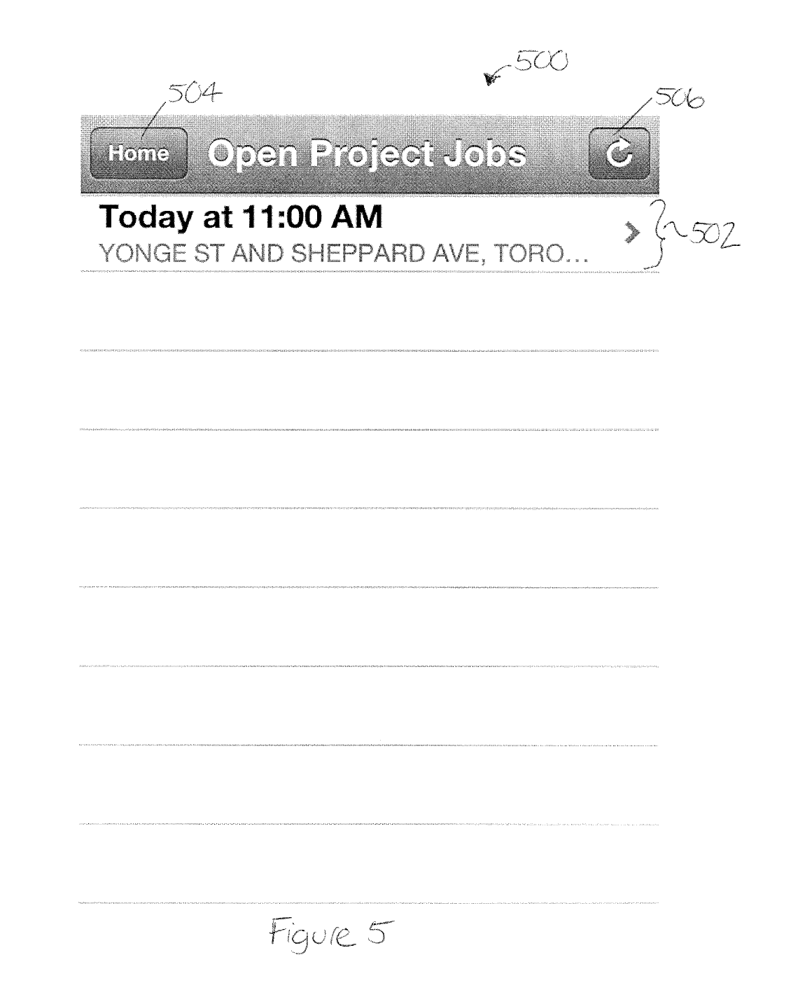

On the project details page, all the relevant details about the survey project are presented to the user (block 306). This may include one or more of the project number, location, survey date, survey time periods, data classes to record, assigned observations, names of surveyors on projects and specific job requirements. When the user is ready to begin a data collection survey, a link to begin, such as a “start job” button or other user-selectable control may be selected to start the survey for the project job. FIG. 6 illustrates an example GUI project details screen 600 for an IPad™ device. In the example shown in FIG. 6, the project details screen 600 shows the user the details of the survey project, including project number and type of survey 602, location 604, survey time periods 608, data classes to be recorded 610, assigned directions 612, assigned surveyors 614, survey date 616 and any further job details 618. From this screen, the user may return to the open project jobs 500 screen by selecting the open project jobs 601 icon. Alternatively, the user may select the start 620 button to start the survey.

Once the user starts a project job, a tutorial on conducting the traffic survey, such as for example a turning movement count type of survey, is presented to the user (block 308). An option may be provided to the user to skip the tutorial. After the user presses start (and in some instances after completion of the tutorial), the process continues to location verification,

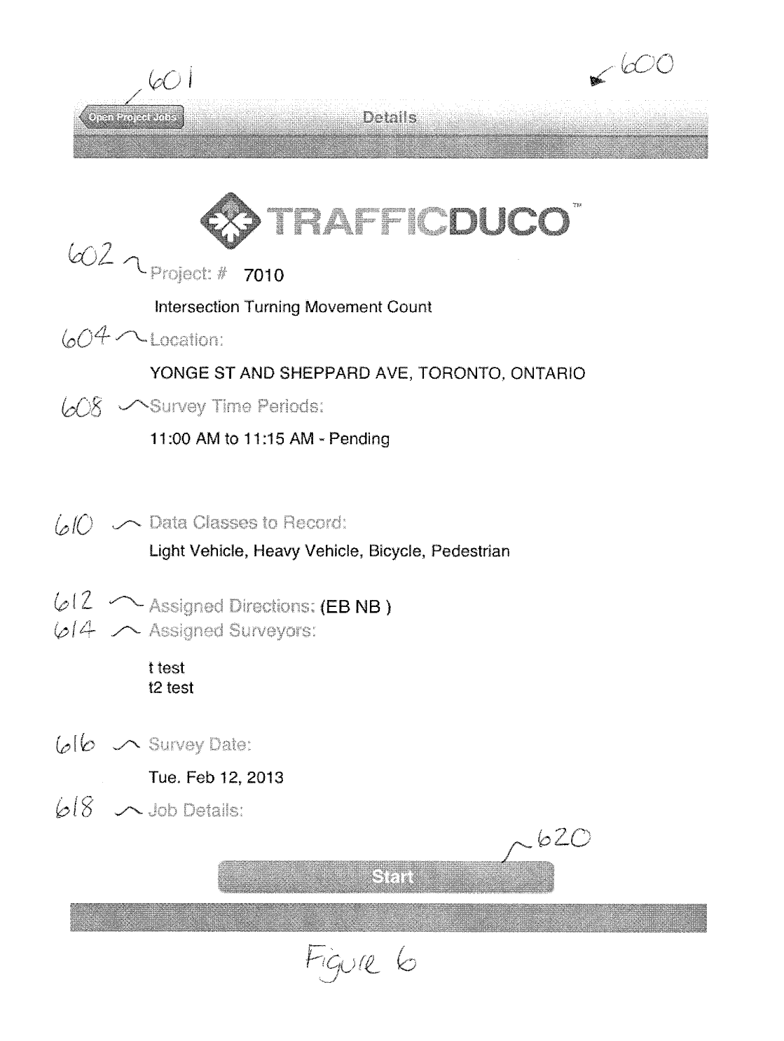

On a confirm location page, a map is presented to the user showing GPS/LPS coordinates of the project job location and the current location of the surveyor's device 100 (and surveyor) (block 310). The user is required to confirm that their location is at the correct project job location. By requiring the user to confirm their location relative to the assigned project job location, the chance that the surveyor will perform the assigned traffic survey at an incorrect location is eliminated. FIG. 7 illustrates an example GUI confirm location screen 700 for an IPad™ device. As shown in FIG. 7, the project job location is identified on the map as a pin 702 and with a label describing the particular location 703. As well, there is an indication 706 on the map identifying the surveyor device's 100 present location (and the surveyor's present location). From the confirm location 700 screen, the user may return to the project details 600 screen by selecting details 708 icon, or may confirm the survey and surveyor device locations by selecting the yes 710 icon,

Once the user's location has been confirmed, a survey setup page is presented to the user (block 312). This page shows the counting/recording screen and permits the user to review the survey requirements and orientate the device 100. For example, the page will label the observation classes to be recorded and provides identification of what type of data class input each GUI button represents which was defined on the cloud-based data management system 55 (for example: tap for 1^{st} class, swipe for 2^{nd} class, hold for third class). For example, a first data class may be light vehicles which may include vehicles that can accelerate at a normal rate, such as a car, pickup truck, van, or motorcycle. A second data class may be heavy vehicles which may include vehicles that accelerate slower than the normal vehicle due to their weight, such as transport trailer trucks, buses and garbage trucks. A third data class may include non-motorized vehicles such as a bicycle. As well, the page permits verification by the user of road conditions (e.g., wet, dry, ice, snow). The page also shows a countdown timer of the time left before the survey time period begins. The surveyor can begin when the countdown timer reaches zero. When the surveyor orients the device 100 using an automatic compass feature, the surveyor will lock the recording screen orientation (block 312). On the screen, the user may view street names and a north compass arrow. The intersection lanes (or legs) assigned will be bright in colour and the lanes (or legs) not assigned will be greyed out and disabled. With the compass feature the intersection information (i.e. street names) will change according to the direction of the surveyor's device 100 (i.e., when facing east, the east leg is at the top, or when facing north, the north leg is at the top). That is, the compass feature automatically changes the input buttons and display depending on the orientation of the user. (i.e., if facing east the east approach input buttons are at the top of the counting screen). Surveyor set up and processing errors are reduced by providing this internal compass for the recording screen where the software application automatically rotates the device's input buttons and labels according to the device's orientation. (e.g. in a turning movement traffic survey, if the devices was facing south, the south side input buttons and street name labels would be on the top of the recording screen). As a result, the end user client has added confidence in the accuracy of the information, regardless of the surveyor's ability recognize the direction they are facing. The user after orientating the surveyor's device 100 may confirm the parameters and lock the screen so the layout doesn't change during the data collection times. By requiring the surveyor to lock the compass before continuing to the survey recordings, input errors are reduced. If the internal compass was not locked, the input buttons and labels on the application screen would change during the survey if the surveyor changed the direction of the surveyor's device 100.

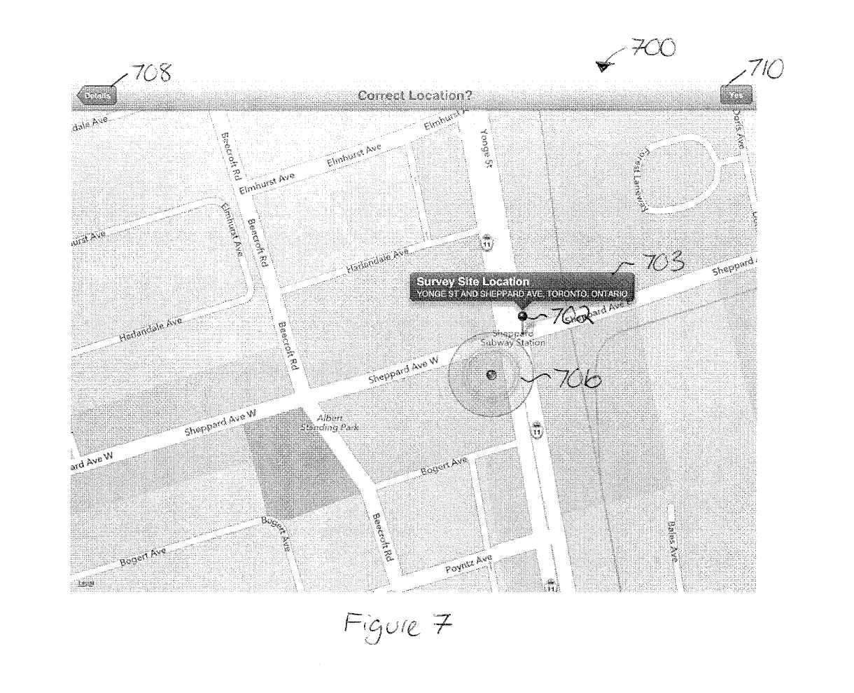

FIG. 8 illustrates an example GUI survey setup screen 800 for an IPhone™ device. As shown in FIG. 8, the observation classes to be recorded and how to record them are identified in section 802 of the screen. As well, the survey setup 800 screen provides arrow buttons 806 to count a vehicle (motorized or non-motorized) that is passing through the intersection and arrow buttons 804 for counting pedestrian traffic. Portions of the location and/or intersection that are not part of the survey or those recordings that were assigned to additional surveyors who are recording the information simultaneously have greyed out icons, such as icons 816. From this screen, the user may also view and modify the present road conditions with selectable icon 814 and view and report any incident at the location with selectable icon 812. A direction icon 820 identifies whether the device orientation is locked; during the survey setup, the direction icon 820 shows an unlocked lock. A timer 808 is displayed and lets the user know the amount of time before the survey is schedule to begin. Finally, the north compass 810 icon is displayed to indicate to the user the surveyor device's 100 present orientation.

Once the user confirms the road conditions and orients the device, the user selects the option to “lock direction and start recording” to begin conducting the survey and recording data (block 314). On a survey recording page, the user can make survey inputs, hear recorded sounds and view the recording log in the centre of the screen. For example, the user may record information relating to primary, secondary, tertiary and pedestrian data classes, road condition changes and incidents. As well, the collected data will be stamped with time and GPS/LPS location information. Using the existing GPS/LPS and time stamping functionality of the surveyor's device 100, the geographic location of the surveyor device 100 (i.e., the survey user) and time information is recorded during the survey. This provides an auditability feature as the recordings are stamped using the surveyor device's 100 internal universal clock as opposed to the surveyor device's 100 displayed time. This provides an audit check for the end user client that the survey was conducted during the required time period in the event a surveyor changes the surveyor device's 100 time clock. As well, a further auditability feature is provided as the GPS/LPS coordinate position of the surveyor device 100 (hence surveyor) is recorded automatically throughout the required survey period. This provides an audit check for the end user clients that the surveyor was at the survey site throughout the required survey period.

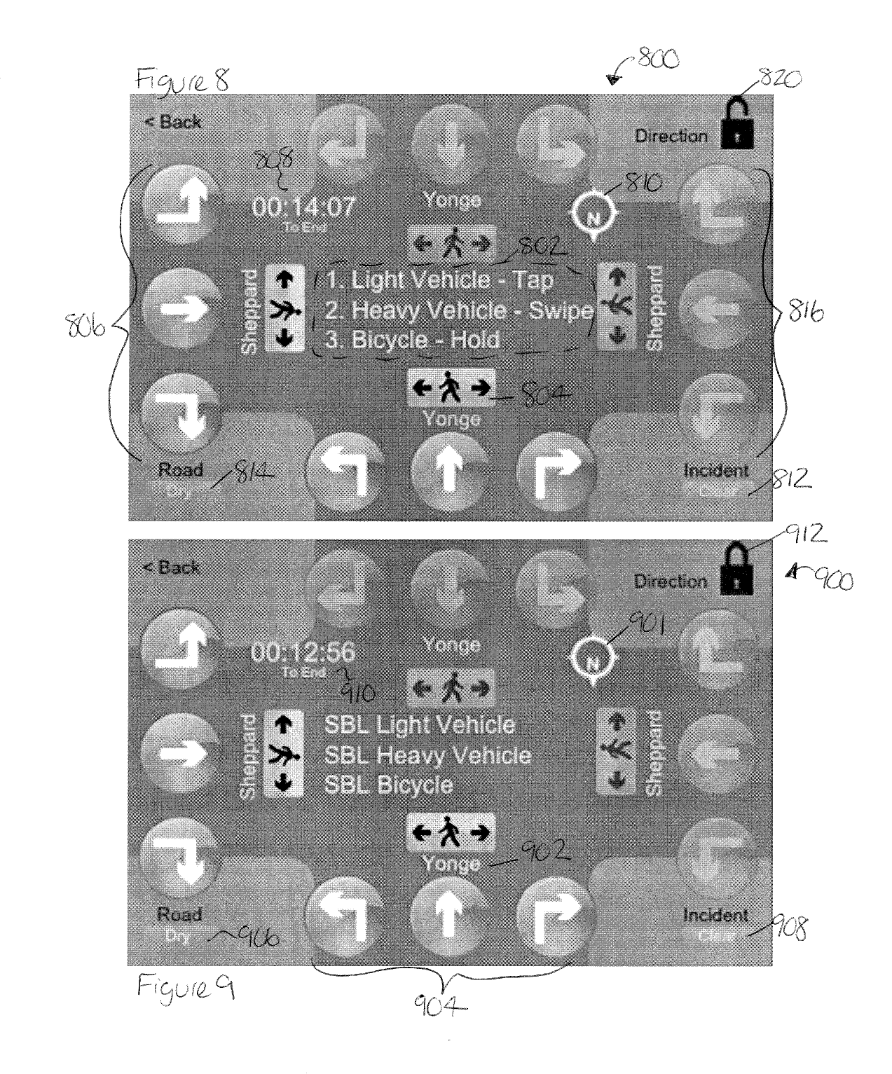

FIG. 9 illustrates an example GUI survey recording screen 900 for an IPhone™ device. As shown in FIG. 9, the screen shows a north compass 901 icon indicating the direction of north relative to the position of the surveyor's device and shows the street names 902 of the location. Primary input buttons 904 are displayed on the screen to record traffic movements at the survey location. The location of the primary input buttons 904 on the device screen is designed to improve accuracy. For all surveyor device screen sizes, all primary input buttons 904 (for the 3 main classes) are located in a position where the surveyor can make recording inputs using their two thumbs while maintaining a consistent hand position. This increases the accuracy of the survey recordings as it enables the surveyor to be better familiar with the primary input button 904 location reducing the number of times the surveyor needs to look down at the device. This thereby increases the time surveyors can maintain eye contact with the observations they are recording.

As well, in some embodiments a separate and distinct sound may be used to indicate an input for each data class required in the survey (i.e., light vehicles, heavy vehicles, non-motorized vehicles). By using a sound for each data class input, accuracy is increased as the surveyor has an audible verification that they recorded the observation for the proper data class. This reduces the number of times the surveyor needs to look down at the device 100 which increases the time surveyors can maintain eye contact with the observations they are recording. Also, in some embodiments, a visual log of recent recordings is displayed on the survey recording screen. The surveyor can quickly look down and confirm visually if the recording was inputted correctly and make adjustments if there was an input error.

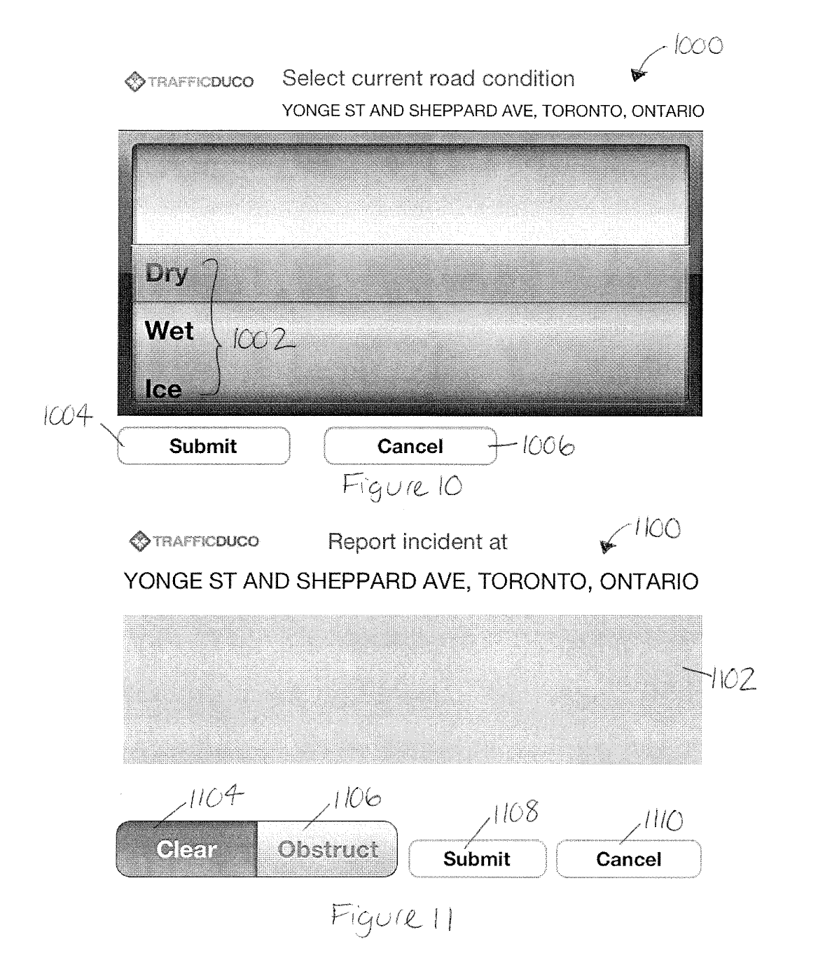

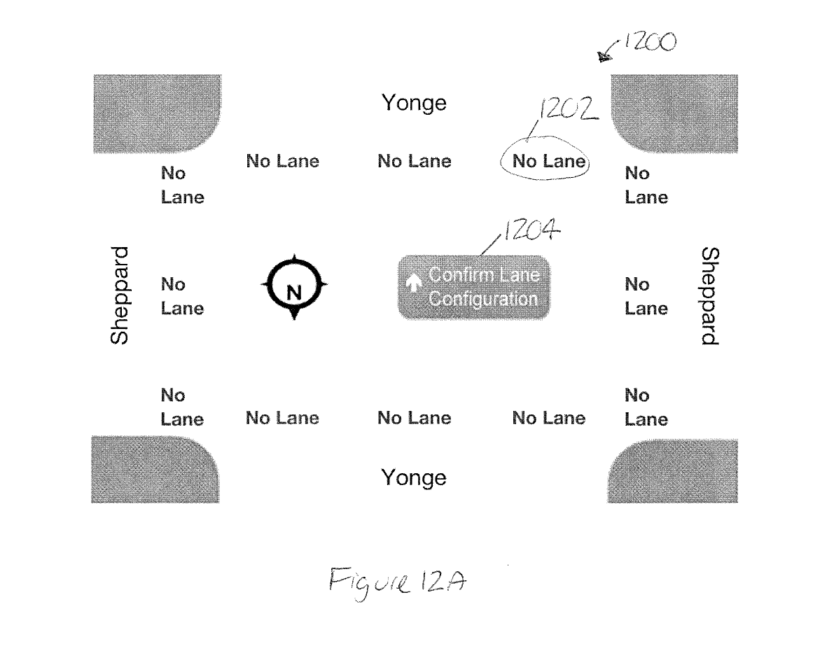

As shown in FIG. 9, a road conditions button 906 is also displayed which allows a survey user to change the road conditions (i.e., wet, dry, ice, snow) should it change during the survey time period. Once the user selects the road conditions button 906, a road condition screen is displayed. FIG. 10 illustrates an example GUI road condition screen 1000 for an IPhone™ device. As shown, the user may select from list options 1002 the present road conditions for the survey location, and may submit the information using submit button 1004 or may select a cancel button 1006 to exit the road condition screen 1000. Also, a report incident button 908 is displayed and allows a survey user to record and describe an incident that may affect the data collection results (i.e. traffic accident, traffic lights out). Once the report incident button 908 is pressed, an incident report screen is displayed. FIG. 11 illustrates an example GUI incident report screen 1100 for an IPhone™ device. As shown, a free form text box 1102 may be displayed for the user to input the information, with a submit button 1108 and a cancel button 1110. Once information is submitted, the report incident button 908 will show the term ‘obstruct’. A user may press the report incident button 908 to view the incident report screen 1100 to indicate whether the incident is finished by selecting the clear button 1104 or to indicate an incident has occurred by selecting the obstruct button 1106. These road conditions and incident reporting options provide additional qualitative data that is electronically time stamped and stored with the survey file, and provides the client with information that may affect the survey results. Additionally, the survey recording screen 900 displays a countdown timer 910 indicating the time until the end of the survey period, at which time the data collection period will automatically end. Finally, a direction icon 912 is displayed and indicates that the device orientation has been locked to ensure consistent and accurate reporting of data.

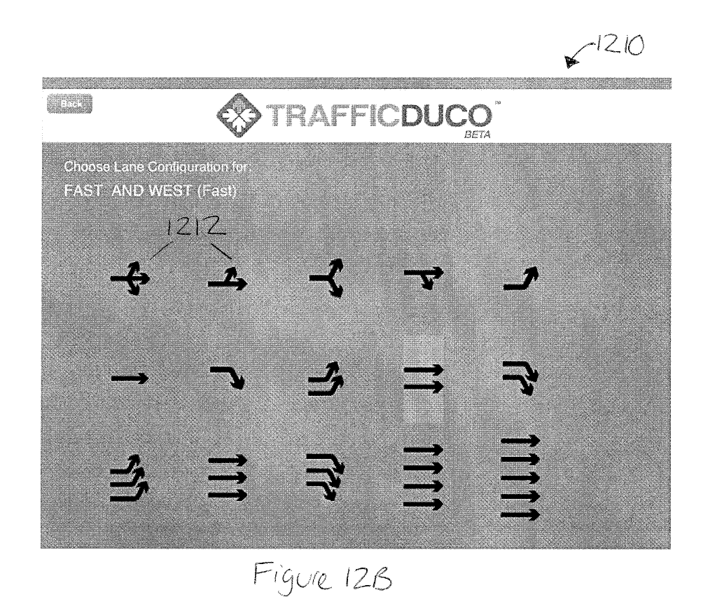

Once the data collection period ends, the user is presented with a survey specific detail confirmation page (block 316). This page is used to confirm details after the primary survey period, which includes necessary information (i.e. lane configurations, ending parking demand) to complete the survey summary. The surveyor must complete and submit the details to confirm that the survey requirements are complete. This information provides a confirmation resource to the end user client but won't change the survey results as the client will make the final confirmation of the information on the web service. FIG. 12A illustrates an example GUI project detail confirmation screen 1200 for an IPhone™ device. As shown, the orientation of the screen 1200 matches the orientation of when the surveyor completed the survey. On this screen 1200, all surveyors are required to select a combination of arrows that can match the number of lanes and movements for each lane at the intersection. This is an important requirement which allows the end client to assess the operations of the intersection properly. The user may select a lane icon 1202 to view available arrow combinations that may be selected on a lane configuration page, FIG. 12B illustrates an example GUI lane configuration screen 1210 having selectable arrow icons 1212 indicating direction and number of lanes. Once the user has selected the lane configurations for the survey location, the user can select the confirm lane configuration button 1204 to submit the selections.

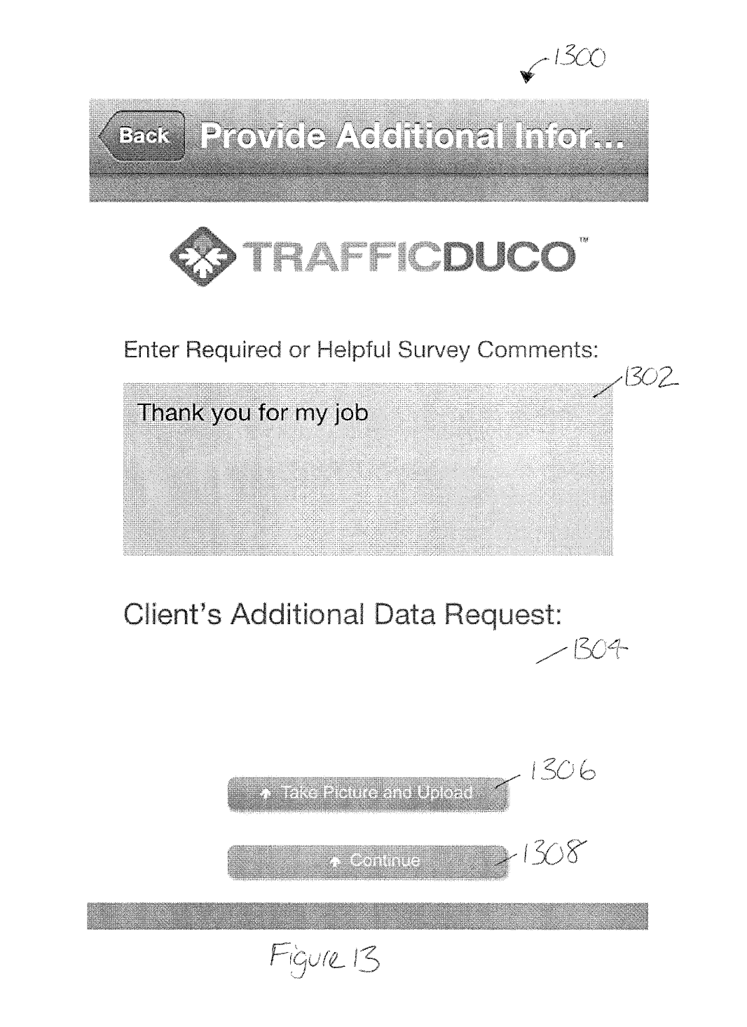

After the further details are confirmed by the user, the user is presented with an additional data and picture upload screen page (block 318). This screen will allow user surveyors to submit any further information or pictures that may or may not be required. If the surveyor was assigned an additional data request, such as pictures of the survey location, a description of the specific request will be displayed. This provides an additional qualitative data that will assist the end user with the analysis of the collected data. As well, it allows the end user client to receive information that they may otherwise normally need to physically investigate themselves. FIG. 13 illustrates an example GUI additional information screen 1300 for an IPhone™ device. As shown, the screen displays a free form text box 1302 where the surveyor may write relevant survey information to attach to the project. As well, the screen displays a description section 1304 of any additional data request(s) made by the client. A surveyor may also select take picture and upload button 1306 for example, to take a picture of the survey location using the surveyor's device and upload the picture to the survey project. Once the surveyor has added any additional comments or pictures, they may select the continue button 1308 to continue to submission of the survey results.

After providing any additional information or data, the user is presented with a confirmation screen page (block 320). This page will ask the surveyor user to confirm all the data collection requirements are complete. By pressing the confirmation, all the data collected will be wirelessly transferred to the cloud-based data management system 55 (block 322). When the data has been transferred successfully it will be deleted from the surveyor device 100 automatically (block 322). By erasing the survey recordings from the surveyor's device 100, data ownership integrity is improved. This ensures that the only copy of the survey original survey data is in the owner's possession and cannot be duplicated by the surveyor to be sold or redistributed. In this way, the collected data can only be viewed after automatically and wirelessly uploading the recorded data to the cloud-based data management system 55 and the data cannot be transferred directly from the surveyor's device 100 to another computer or device. This eliminates the opportunity for raw data recordings from the surveyor to be changed, modified or manipulated before the end user (i.e., client) who posted the project on the cloud-based data management system receives the survey information. Ensuring that the client receives the true raw recordings (Le., the collected transportation data) thereby maintains the integrity of the survey recordings. As well, the recordings provide improved detailed information by using, for example, one minute data bins that show the consistency of inputs throughout the survey and provide more defined summary results.

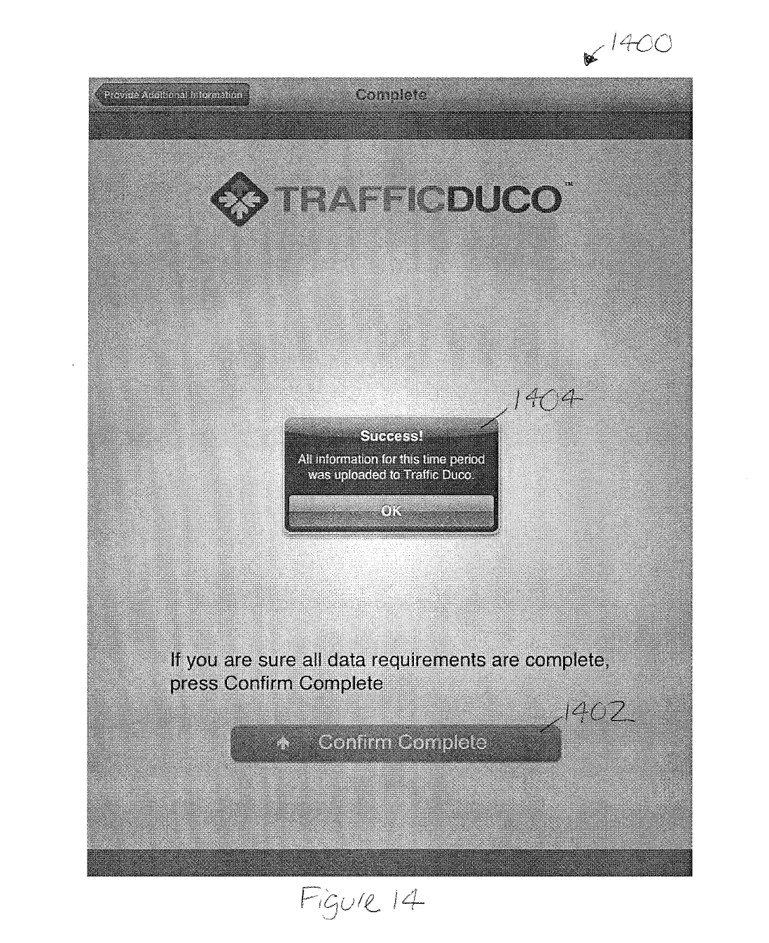

On a upload confirmation page, there is a message, such as a pop-up window, confirming a successful upload, that is that the data is received, and the pop-up may show the data (block 324). Processing time is reduced as the survey recordings wirelessly transmitted to the cloud-based data management system 55 are provided to the end user client in a summary report format that is available immediately after the end of the survey. If applicable, an indication of the time left to the next survey period may be displayed on the surveyor device 100 screen if there is a multiple survey period (block 324). Survey flexibility and processing time is improved by providing functionality in the software application for multiple time period survey projects without needing to input any further setup information or store separate files. This further simplifies the survey process and helps prevent errors. FIG. 14 illustrates an example GUI confirmation and upload screen 1300 for an IPad™ device. As shown, the user may select a confirm complete 1402 button to confirm that all requirements for the survey are completed. A pop-up window 1404 will appear on the screen to confirm that all the data has been successfully updated to the system.

In the case of multiple surveyors, survey flexibility is provided and data processing time is reduced for end user clients. Functionality in the cloud-based data management system 55 provides for survey projects that require more than one surveyor. That is, the cloud-based data management system 55 may be used to divide up the data collection project into multiple smaller surveys or tasks that may be completed by the multiple surveyors. For example, surveys that have high frequency of observations or observations that need to be made a multiple locations simultaneously may require more than one surveyor to accurately record all observations. If there are more than one surveyor on a survey project, then multiple electronic devices may receive the data collection setup information in order for the multiple surveyors to simultaneously collect (i.e. record) transportation data to complete the data collection project. The data collection setup information may delineate the survey requirements for each surveyor to complete. The recordings from multiple surveyor devices are transmitted to the cloud-based data management system 55 in a format that can be merged together into one project data file. Currently in conventional solutions, surveys requiring multiple surveyors, require the end user to setup and process the multiple survey data files and then manually merge the data files to summarize the overall survey results.

Although in some instances the example process and example GUI screens described above refer to a turning count survey type, the process and software application of the present application may be used for any type of transportation survey.

The scope of the claims should not be limited by the embodiments set forth in the examples, but should be given the broadest interpretation consistent with the description as a whole.

1. A method of data collection, the method comprising:
receiving, on an electronic device, data collection setup information from a server;
generating, for display on a graphical interface screen of the electronic device a data collection application configured with the data collection setup information;
receiving, through the data collection application, user inputted transportation data;
storing, on the electronic device, the collected transportation data; and
transmitting, to the server, the collected transportation data

2. The method of claim 1, comprising:
automatically deleting, from the electronic device, the stored collected transportation data immediately after the collected transportation data is transmitted to the server.

3. The method of claim 1, comprising:
determining an orientation of the electronic device; and
modifying, based on the determined orientation, a position of one or more objects on the screen of the data collection application.

4. The method of claim 3, comprising:
locking, based on the determined orientation of the electronic device, the position of the one or more objects on the screen of the data collection application during a data collection time period.

5. The method of claim 1, wherein the electronic device is configured to automatically receive the data collection setup information prior to a scheduled data collection project.

6. The method of claim 1, comprising:
preventing modification of the collected transportation data after the end of a data collection time period,

7. The method of claim 1, comprising:
displaying, on the screen, an indicator of the position of a survey location and an indicator of the position of the electronic device; and
receiving, on the electronic device, an input confirming that the electronic device is positioned at the survey location.

8. The method of claim 1, comprising:
determining, on the electronic device, positioning information of the electronic device; and
storing the positioning information with the collected transportation data.

9. The method of claim 1, comprising:
determining, on the electronic device, time and date information; and
storing the time and date information with the collected transportation data.

10. The method of claim 1, wherein the data collection setup information includes one or more of survey location, survey date, survey time period, and transportation data classes.

11. The method of claim 1, wherein more than one electronic device receives the data collection setup information for simultaneous collection of transportation data to complete a data collection project.

12. An electronic device, comprising:
a processor;
a memory for storing transportation data; and
a communications subsystem;
the processor being configured to:
receive data collection setup information from a server;
generate, for display on a graphical interface screen a data collection application configured with the data collection setup information;
receive, through the data collection application, user inputted transportation data;
store, in the memory, the collected transportation data; and
transmit, to the server, the collected transportation data.

13. The device of claim 12, wherein the processor is further configured to automatically delete the stored collected transportation data immediately after the collected transportation data is transmitted to the server.

14. The device of claim 12, further comprising a positioning information system, wherein the processor is further configured to:
determine an orientation of the electronic device; and
modify, based on the determined orientation, a position of one or more objects on the screen of the data collection application.

15. The device of claim 14, wherein the processor is further configured to:
lock, based on the determined orientation, the position of the one or more objects on the screen of the data collection application during a data collection time period.

16. The device of claim 12, wherein the processor is further configured to automatically receive the data collection setup information prior to a scheduled data collection project.

17. The device of claim 12, wherein the processor is further configured to prevent modification of the collected transportation data after the end of a data collection time period,

18. The device of claim 12, further comprising a positioning system, wherein the processor is further configured to:
determine positioning information of the electronic device; and
store the positioning information with the collected transportation data.

19. The device of claim 12, further comprising a universal clock, wherein the processor is further configured to:
determine time and date information; and
store the time and date information with the collected transportation data.

20. A non-transitory computer readable storage medium having instructions stored thereon, which when executed by a processor for facilitating data collection, the processor performs the method of claim 1.
